(19) United States
(12) Patent Application Publication
(10) Pub. No.: US 2024/0339684 A1
(43) Pub. Date: Oct. 10, 2024

(54) METHOD FOR CHARGING A RECHARGEABLE BATTERY OF A MOBILE POWER TOOL, AND CHARGING APPARATUS

(71) Applicant: Hilti Aktiengesellschaft, Schaan (LI)

(72) Inventors: Johannes LANDESFEIND, Wielenbach (DE); Philipp BRAUN, Kaufbeuren (DE)

(21) Appl. No.: 18/700,018

(22) PCT Filed: Nov. 17, 2022
(86) PCT No.: PCT/EP2022/082180

§ 371 Date: Apr. 10, 2024

(30) Foreign Application Priority Data
Dec. 1, 2021 (EP) 21211565.3

(51) Int. Cl. H01M 10/44; H01M 10/0525; H01M 10/48; H02J 7/00

(52) U.S. Cl. CPC H01M 10/443; H01M 10/486; H02J 7/007194; H01M 10/0525; H01M 2220/30

(57) ABSTRACT

In a method for charging a rechargeable battery of a mobile power tool, wherein the rechargeable battery has an electrolyte that is liquid at room temperature, charging is carried out at least temporarily at a core temperature (TK) of at least 60° C. and at a charging rate of at least 3 C. A charging apparatus is also provided.

The invention relates to a method for charging a rechargeable battery of a mobile power tool.

If hand-held power tools are used on a construction site, they should be able to be used with as few interruptions as possible. However, in the case of hand-held power tools that can be operated cordlessly, in particular if they have a rechargeable battery as an energy store, it is regularly necessary to recharge the rechargeable battery. This means that work with the hand-held power tools is interrupted while their rechargeable batteries have to be charged. Alternatively, it is possible to use a plurality of rechargeable batteries as interchangeable rechargeable batteries. However, this is associated with high acquisition costs.

The object of the present invention is therefore to provide a method for charging a rechargeable battery of a mobile power tool, with which the rechargeable battery of the hand-held power tool can be charged particularly quickly. Furthermore, the intention is to present a charging apparatus that makes it possible to charge a rechargeable battery of a mobile power tool particularly quickly.

The object is initially achieved by a method for charging a rechargeable battery of a mobile power tool, wherein the rechargeable battery has an electrolyte that is liquid at room temperature and is charged at least temporarily at a core temperature of at least 60° C. at a charging rate of at least 3 C.

A charging rate of xC can be understood as meaning the current intensity which is required to fully charge a discharged rechargeable battery in a fraction of an hour corresponding to the numerical value x of the charging rate x C. A charging rate of 3 C thus makes it possible to fully charge rechargeable battery within 20 minutes.

As a concept, the invention is based on the fact that the viscosity of the liquid electrolyte can decrease with increasing temperature, in particular increasing core temperature, of the rechargeable battery and thus also of the electrolyte. In particular, particularly favorable viscosities can be achieved at temperatures of at least 60° C. Lowering the viscosity makes it possible to in turn lower an internal resistance of the rechargeable battery. This allows higher charging currents and/or lower power losses to be achieved.

A further concept is that an effect known as “lithium plating” can be reduced or avoided at such a core temperature compared to lower core temperatures.

The mobile power tool can be and/or comprise a hand-held power tool. Alternatively or additionally, the mobile power tool can also be in the form of a construction robot. In particular, it can be designed for use on a construction site, for example a building construction site and/or a civil engineering construction site. It can be designed for drilling, cutting-off, for example sawing or cutting, pressing and/or grinding.

For example, room temperature may correspond to a temperature in a range of from 19° C. to 23° C. In particular, room temperature can correspond to 21° C., for example.

The electrolyte can have a viscosity of at least 0.1 mPa s. It can have a maximum viscosity of 10 mPa s. The electrolyte can have a transference number for lithium transport of between 0.3 and 0.7 at room temperature and 1 bar atmospheric pressure. It can have a diffusion coefficient at room temperature and 1 bar atmospheric pressure for lithium transport of between 3×10⁻⁶ cm²/s and 20×10⁻⁶ cm²/s.

In particular, the electrolyte can have approximately 1 molar LiPF₆ in a mixture of ethylene carbonate and dimethyl carbonate. The mixture can have a weight fraction ratio of 3:7.

In order to avoid overheating of the rechargeable battery, provision can be made for the charging rate to be reduced and/or the charging process to be interrupted when the core temperature reaches or exceeds a limit temperature. The limit temperature can be between 70° C. and 95° C., in particular 80° C., for example. The charging rate can be reduced to 1 C or less. For example, it can be reduced to a maximum of 0.5 C. The charging rate can be reduced or the charging process interrupted for a specific period of time.

The rechargeable battery can be lithium-based. As an alternative or in addition, it can also be sodium-based. It is also conceivable for the rechargeable battery to be magnesium-based. The rechargeable battery can have a rated voltage of at least 20 V, in particular at least 28 V, for example 36 V.

The rechargeable battery can comprise at least one pouch cell. It can thus be designed as a cuboid or at least substantially as a cuboid. Alternatively or additionally, the rechargeable battery can also have a cylindrical shape.

The rechargeable battery can also be tubular.

The rechargeable battery can have at least one individual cell. The individual cell and/or the rechargeable battery can have at least one housing. Consequently, the rechargeable battery can be designed as a rechargeable battery pack, in particular having a plurality of individual cells.

In order to increase the service life, provision may be made for charging to take place on the basis of an operating state of the rechargeable battery. The operating state can correspond to a state of health of the rechargeable battery. For example, it can correspond to the ratio of the internal resistance to an initial value of the internal resistance of the rechargeable battery. Alternatively or additionally, the operating state can also correspond to a temperature, in particular to a temperature other than the core temperature. It is also conceivable for the operating state to comprise a time series, in particular regarding the use of the rechargeable battery, for example in each case in the last 30 minutes before charging begins.

In particular, it is conceivable for charging to take place at the core temperature of at least 60° C., depending on a state of charge of the rechargeable battery. For example, charging at at least 3 C can take place with a state of charge of at least 20% and/or at most 80%, for example between 30% and 60%. It is also conceivable to charge a specific proportion of the total capacity of the rechargeable battery at the respective charging rate. For example, provision may be made for 50% of the capacity of the rechargeable battery to be charged at at least 3 C at more than 60° C.

It is conceivable in this case for the core temperature to be measured. For this purpose, a temperature sensor can be arranged in and/or on the rechargeable battery. It is also conceivable for a charging apparatus to have a temperature sensor. The temperature sensor can preferably be configured to measure the core temperature. The temperature sensor can be arranged on the charging apparatus in such a way that it touches and/or penetrates the rechargeable battery as soon as it is arranged in a charging bay of the charging apparatus.

Alternatively or additionally, it is also conceivable for the core temperature to be estimated. In this case, the estimation of the core temperature can be based on a measurement of another temperature, for example a surface temperature of the rechargeable battery. Alternatively or additionally, the estimation can also be based on electrical parameters, for example a charging current and/or a charging voltage, of the rechargeable battery and/or the charging process.

If such an estimation of the core temperature is carried out, the method can be used without the need for special preparation of the rechargeable battery beforehand. In particular, there is no need to install a temperature sensor in the rechargeable battery in order to measure the core temperature.

It is also conceivable for a thermal resistance of the rechargeable battery to be increased and/or reduced at least temporarily during charging. For example, it is conceivable for the rechargeable battery to be brought into a thermally insulated region for charging. For example, this can be a region with thermally insulated walls. For this purpose, the charging bay of the charging apparatus can have thermally insulated walls. Thus, an effective thermal resistance of the rechargeable battery can be increased. Heat that is present and/or generated in the rechargeable battery during charging can thus be retained better in the rechargeable battery. The rechargeable battery can thus warm up faster to the desired core temperature of at least 60° C. and/or maintain its core temperature. Alternatively or additionally, it is also conceivable for the rechargeable battery to be temporarily exposed to a fluid flow, in particular an air flow. For example, a fan can be switched on or off intermittently. The fan can be configured to convey an air flow to the rechargeable battery. In particular, this makes it possible to reduce the effective thermal resistance when the fan is switched on. This can be used, for example, when the core temperature reaches or exceeds the limit temperature. A further increase in the core temperature can thus be slowed down or stopped, or the core temperature can be reduced.

A charging apparatus for charging a rechargeable battery of a mobile power tool also falls within the scope of the invention, wherein the charging apparatus is configured to detect a core temperature of the rechargeable battery. The charging apparatus can thus detect the core temperature of the rechargeable battery in order to use it to control a charging process of the rechargeable battery, in particular in the manner described above. The charging apparatus can be integrated in the mobile power tool. Alternatively, the charging apparatus can also be in the form of an independent device. In particular, it can be designed independently of the mobile power tool.

For this purpose, the charging apparatus can have a temperature sensor and/or an interface for a temperature sensor for measuring a temperature of the rechargeable battery. The temperature sensor can be a surface temperature sensor for measuring a surface temperature of the rechargeable battery. Alternatively or additionally, the temperature sensor can also be configured to directly measure the core temperature.

For example, the temperature sensor can be inserted into a core of the rechargeable battery for this purpose.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combinations in variants of the invention.

Exemplary embodiments of the invention are shown in the schematic drawing and explained in more detail in the following description.

### In the Drawing:

FIG. 1 shows a mobile power tool;

FIG. 2 shows a block diagram of a charging apparatus with a rechargeable battery, and

FIG. 3 shows a flowchart of a method for charging a rechargeable battery.

In order to make it easier to understand the invention, the same reference signs are used in each case for identical or functionally corresponding elements in the following description of the figures.

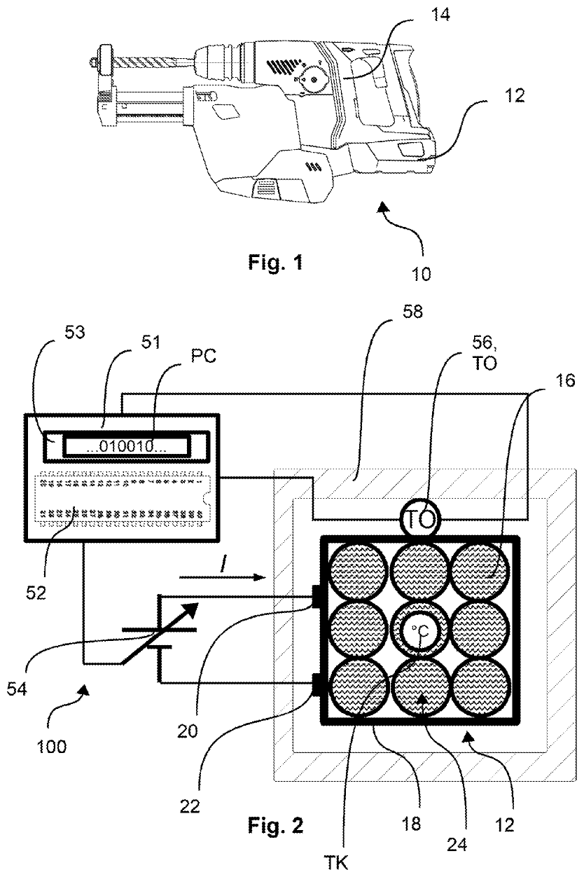

FIG. 1 shows a mobile power tool 10. The mobile power tool 10 is, for example, an electropneumatic hammer drill. The mobile power tool 10 can be operated cordlessly. For this purpose, it has a rechargeable battery 12. The rechargeable battery 12 is detachably arranged on a housing 14 of the mobile power tool 10. It can thus be detached from the mobile power tool 10, for example for charging. It can then be arranged on the mobile power tool 10 again, so that work can continue with the mobile power tool 10.

FIG. 2 now shows a schematic illustration of a charging apparatus 100. The charging apparatus 100 is configured to charge the rechargeable battery 12. This is shown in a schematic cross-sectional view in FIG. 2.

The rechargeable battery 12 has a multiplicity of individual cells 16, only one individual cell 16 of which is provided with a reference sign in FIG. 2 by way of example. The individual cells 16 are integrated in a rechargeable battery housing 18. By way of example, the individual cells 16 are cylindrical. Alternatively, it is also conceivable for the individual cells 16 to be cuboidal or at least substantially cuboidal. For example, they can also be in the form of pouch cells. They can be stacked on top of one another inside the rechargeable battery 12.

There are two electrodes 20, 22 on the rechargeable battery housing 18. The rechargeable battery 12 can be charged with a charging current I via the electrodes 20, 22. The rechargeable battery 12 can have a rated voltage of 36 V, for example.

Likewise, in principle, current can be drawn from the rechargeable battery 12 via the electrodes 20, 22.

Each individual cell 16 of the rechargeable battery 12 has an electrolyte 24 which is schematically illustrated in the form of a filling pattern inside the individual cells 16 of the rechargeable battery 12 in FIG. 2, wherein only one of the filling patterns is provided with the associated reference sign in FIG. 2 by way of example. It goes without saying that the individual cells 16 have yet further components, in particular lithium-containing material, in their interior. However, these are not illustrated in FIG. 2 for reasons of presentation.

The rechargeable battery 12, and in particular each of the individual cells 16 of the rechargeable battery 12, is based on lithium ions.

In the core of each individual cell 16, there is a core temperature TK. By way of example, the core temperature TK is marked in FIG. 2 using one of the individual cells 16.

The electrolyte 24 is liquid at a room temperature of, for example, 21° C. and an atmospheric pressure of 1 bar. For example, it may be 1 molar LiPF₆ in a mixture of ethylene carbonate and dimethyl carbonate. The mixture can have a weight fraction ratio of 3:7. When heated, in particular above 60° C., the viscosity of the electrolyte 24 can be reduced.

In this exemplary embodiment, the charging apparatus 100 is in the form of an independent device. Alternatively, it is also conceivable for the charging apparatus 100 to be integrated in the mobile power tool 10 (FIG. 1), for example.

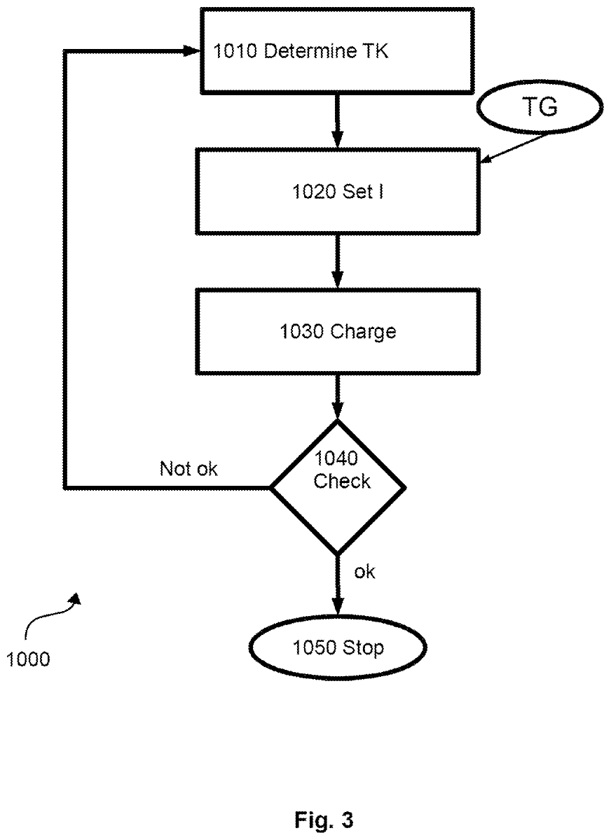

The charging apparatus 100 has a microcontroller 51. The microcontroller 51 comprises a microprocessor 52, a storage unit 53 as well as program code PC which is stored in the storage unit 53 in an executable manner. The program code PC is designed in such a way that the microcontroller 51 is configured overall to charge the rechargeable battery 12 by means of the charging apparatus 100 and in accordance with the method explained in more detail above and below with reference to FIG. 3.

The charging apparatus 100 also has an adjustable voltage source 54. The adjustable voltage source 54 is electrically connected to the rechargeable battery 12 via the electrodes 20, 22. It is configured to provide DC voltage.

The rechargeable battery 12 can thus be charged via the adjustable voltage source 54.

Furthermore, the charging apparatus 100 has a temperature sensor 56. The temperature sensor 56 is arranged on the rechargeable battery housing 18 of the rechargeable battery 12. It is thus configured to detect a surface temperature TO of the rechargeable battery 12. It is also connected to the microcontroller 51 using data technology, with the result that the microcontroller can read out measured temperature values from the temperature sensor 56.

The charging apparatus 100 also has a heat protection housing 58. The heat protection housing 58 forms a receptacle for the rechargeable battery 12 to be charged. Its wall is formed from a heat-insulating material, in particular a material that is protected against fire. For example, it can have a fiber material and/or a foam material, for example based on polyurethane. The material can be provided with a flame retardant.

FIG. 3 now shows a method 1000 for charging a rechargeable battery of a mobile power tool. The method 1000 is explained in more detail below. In this respect, reference is made to the reference signs introduced in FIGS. 1 and 2.

During a measurement 1010, the surface temperature TO of the rechargeable battery 12 is measured by means of the temperature sensor 54. The core temperature TK is estimated by the microcontroller 51 from the surface temperature TO by means of a thermal model of the rechargeable battery 12 coded in the program code PC. In this case, the estimated core temperature TK can relate, for example, to the highest core temperature TK of all individual cells 16.

The charging current I of the rechargeable battery 12 is then set 1020 depending on the estimated core temperature TK. In this case, the charging current I is set according to a charging rate of 1.5 C if the estimated core temperature TK is in the range below 60° C. In a temperature range from 60° C. to 75° C., the charging current I is set according to a charging rate of 5 C. If the estimated core temperature TK is in a range between 75° C. and a limit temperature TG, for example 80° C., the charging current I is set according to a charging rate of 1 C. If the estimated core temperature TK is higher than the limit temperature TG, i.e. higher than 80° C. in this exemplary embodiment, the charging current I is reduced according to a charging rate of 0.1 C.

During subsequent charging 1030, the rechargeable battery 12 is charged with the charging current I that has been set via the adjustable voltage source 56, for example over a period of 1 second. A decision 1040 then checks the state of charge of the rechargeable battery 12. If the state of charge exceeds a desired target state of charge, for example 98% of the total capacity of the rechargeable battery 12, the charging current I is switched off and the method comes to an end of the method 1050. Otherwise the method is continued again with a new measurement 1010.

In variants of the method 1000, instead of charging with a charging current I that is constant at least for certain periods of time, a more complex time profile of the charging current I can also be provided. For example, the charging current I can be pulsed, at least temporarily. The charging current I can be a direct current. It can also, at least temporarily, correspond to a clocked direct current. It can be pulsed with constant and/or varying pulse widths. The shape of at least one pulse can be rectangular or at least substantially rectangular, i.e. with the exception of falling or rising edges and possibly with the exception of noise or other interference components. The shape of at least one pulse can also be non-rectangular, for example in the form of a triangular pulse or in the form of a sinusoidal half-cycle or at least substantially in the form of a triangular pulse or a sinusoidal half-cycle.

A partial discharge, in particular a brief one, can take place between at least one pulse and a further pulse. For this purpose, the polarity of the charging current I can be reversed to form a discharge current.

### LIST OF REFERENCE SIGNS

10 Power tool
12 Rechargeable battery
14 Housing
16 Individual cells
18 Rechargeable battery housing
20 Electrode
22 Electrode
24 Electrolyte
51 Microcontroller
52 Microprocessor
53 Storage unit
54 Voltage source
56 Temperature sensor
58 Thermal protection housing
100 Charging apparatus
1000 Method
1010 Measurement
1020 Setting
1030 Charging
1040 Decision
1050 End of the method
I Charging current
PC Program code
TG Limit temperature
TC Core temperature
TO Surface temperature

1. A method for charging a rechargeable battery of a mobile power tool, wherein the rechargeable battery has an electrolyte that is liquid at room temperature, wherein the rechargeable battery comprises at least one pouch cell, and wherein charging is carried out at least temporarily at a core temperature (TK) of at least 60° C. and at a charging rate of at least 3 C.

2. The method as claimed in claim 1, wherein the charging rate is reduced and/or a charging process is interrupted when the core temperature (TK) reaches or exceeds a limit temperature (TG).

3. The method as claimed in claim 1, wherein the rechargeable battery is lithium-based.

4. The method as claimed in claim 1, wherein charging takes place on a basis of an operating state of the rechargeable battery.

5. The method as claimed in claim 1, wherein charging takes place at the core temperature (TK) of at least 60° C., depending on a state of charge of the rechargeable battery.

6. The method as claimed in claim 1, including measuring the core temperature.

7. The method as claimed in claim 1, including estimating the core temperature (TK).

8. The method as claimed in claim 1, wherein an effective thermal resistance of the rechargeable battery is increased and/or reduced at least temporarily during charging.

9. A charging apparatus for charging a rechargeable battery of a mobile power tool, wherein the charging apparatus is configured to detect a core temperature (TK) of the rechargeable battery.

10. The charging apparatus as claimed in claim 9, wherein the charging apparatus has a temperature sensor and/or an interface for a temperature sensor for measuring a temperature of the rechargeable battery.

11. The charging apparatus as claimed in claim 9, wherein the charging apparatus is configured to charge a rechargeable battery for a mobile power tool, wherein the rechargeable battery comprises at least one pouch cell, according to a method comprising charging at least temporarily at a core temperature (TK) of at least 60° C. and at a charging rate of at least 3 C.

12. The method as claimed in claim 2, wherein the rechargeable battery is lithium-based.

13. The method as claimed in claim 2, wherein charging takes place on a basis of an operating state of the rechargeable battery.

14. The method as claimed in claim 2, wherein charging takes place at the core temperature (TK) of at least 60° C., depending on a state of charge of the rechargeable battery.

15. The method as claimed in claim 2, including measuring the core temperature.

16. The method as claimed in claim 2, including estimating the core temperature (TK).

17. The method as claimed in claim 2, wherein an effective thermal resistance of the rechargeable battery is increased and/or reduced at least temporarily during charging.

18. The charging apparatus as claimed in claim 10, wherein the charging apparatus is configured to charge a rechargeable battery for a mobile power tool, wherein the rechargeable battery comprises at least one pouch cell, according to a method comprising charging at least temporarily at a core temperature (TK) of at least 60° C. and at a charging rate of at least 3 C.

19. The method as claimed in claim 3, wherein charging takes place on a basis of an operating state of the rechargeable battery.

20. The method as claimed in claim 1, wherein charging takes place at the core temperature (TK) of at least 60° C., depending on a state of charge of the rechargeable battery.
